(19) United States
(12) Patent Application Publication
(10) Pub. No.: US 2022/0381380 A1
(43) Pub. Date: Dec. 1, 2022

(54) THREADED JOINT WITH SEALING SURFACE CARRIED OUT BY ADDITIVE MANUFACTURING

(71) Applicant: VALLOUREC OIL AND GAS FRANCE, Aulnoye-Aymeries (FR)

(72) Inventor: Eric VERGER, Meudon (FR)

(73) Assignee: VALLOUREC OIL AND GAS FRANCE, Aulnoye-Aymeries (FR)

(21) Appl. No.: 17/767,337

(22) PCT Filed: Oct. 6, 2020
(86) PCT No.: PCT/EP2020/077921

§ 371 Date: Apr. 7, 2022

(30) Foreign Application Priority Data
Oct. 8, 2019 (FR) FR1911148

(51) Int. Cl. F16L 15/00; E21B 17/042

(52) U.S. Cl. CPC F16L 15/001; E21B 17/042

(57) ABSTRACT

A tubular threaded joint for drilling, operating hydrocarbon wells, or transporting oil and gas includes a male tubular threaded element and a female tubular threaded element. The female tubular threaded element includes a female internal threaded portion and a female non-threaded portion. The male tubular threaded element includes a male external threaded portion and a male non-threaded portion. At least the male or female tubular element includes a body and a portion added by additive manufacturing that includes at least one first abutment surface.

The invention relates to tubular threaded components made of steel and more particularly a tubular threaded joint comprising a sealing surface carried out by additive manufacturing, for drilling, operating hydrocarbon wells or transporting oil and gas.

“Component” here means any element or accessory used for drilling or operating a well and comprising at least one connection or connector or threaded end, and intended for being assembled via a threading to another component to constitute with this another component a tubular threaded joint. The component can be for example a tubular element of relatively long length (in particular of about ten metres in length), for example a tube, or a tubular sleeve of a few tens of centimetres in length, or an accessory of these tubular elements (suspension device or “hanger”, section change part or “cross-over”, safety valve, connector for drilling rod or “tool joint”, “sub”, and similar).

Tubular joints are provided with threaded ends. These threaded ends are complementary allowing two male tubular (“Pin”) and female (“Box”) elements to be connected together. There is therefore a male threaded end and a female threaded end. The threaded ends referred to as premium or semi-premium generally include at least one abutment surface. A first abutment can be formed by two surfaces of two threaded ends, oriented in a substantially radial manner, configured so as to be put into contact with one another at the end of the screwing of the threaded ends together or during compression stresses. The abutments generally have negative angles in relation to the main axis of the connections. Also known are intermediate abutments on joints including at least two threading stages.

Generally, for technical and machining reasons, the different portions of the same component, whether it be the tubular element or threaded ends, are designed according to a single and same type of material (alloy or not).

Premium connections include sealing surfaces, at least one on the pin, and at least one correspondent on the box, intended for being put into interfering contact when pin and box connection are assembled with each other, so as to form a seal to liquids and/or gases. The sealing surfaces must maintain a seal that prevents the passing of liquids and/or gases when the connections are assembled and during the use of tubes including these assembled connections in an oil well column, i.e. the sealing function has to be maintained within the widest spectrum of use possible, including when the connection is subjected to an internal pressure or to an external pressure, to compression stresses or traction stresses, at ambient temperature or at a high temperature, this spectrum corresponding to an operating range of the connection.

The corresponding male and female sealing surfaces then have a radial interference that generates a contact pressure and the so-called “carrier” thread flanks located on the thread on the side opposite the free end of the threaded element are in contact under contact pressure, thus placing the lip under axial compression.

The interfering sealing surfaces can cause jamming problems during screwing if their geometry is unsuitable. They can also cause risks of leakage in service if the contact pressure and in particular the integrated contact pressure over the active width of the sealing surfaces is insufficient.

To prevent the risk of leakage it is necessary that the integrated contact pressure over the contact length remains higher than a certain value expressed in N/mm; this integrated contact pressure is according to a given geometry of the relative positioning of the elements at the end of screwing and stresses in service.

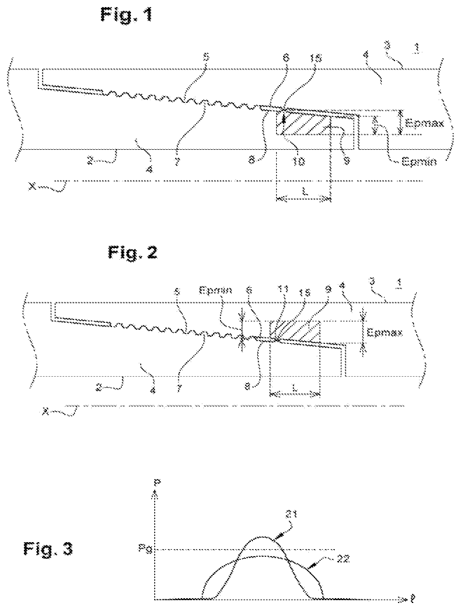

The interference is the result of the difference in diameter between male (Dm) and female (Df) surface in the sealing pressure zone. As the difference Dm−Df is positive the male diameter is greater than the female diameter. Thus, at the interface 11 (see FIGS. 1 and 2) contact pressures are generated.

“Frustoconical” means the shape of a truncated cone, i.e. the basal portion of a solid cone or of a pyramid formed by cutting the top by a plane parallel to the base, and “toroidal” means the shape of a torus.

In general, sealing surfaces are designed to work in the elastic range of the material that they are formed from so as to maintain the sealing quality under various successive stresses.

However, to provide a good seal, sealing surfaces have to be assembled so as to create high contact pressures. It can occur, in particular during assembly, when high performance is sought, that exceedingly high contact pressures are reached, with risks of plasticising, or encore des risks of jamming. “Jamming” means cases where the material is pulled off: In case of jamming, the sealing function is highly compromised.

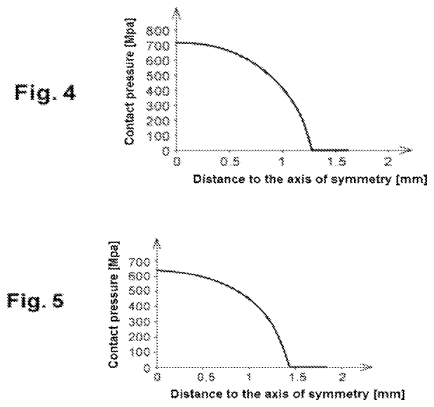

In general in the prior art, either to reduce the contact pressure peak the contact radius is increased, but this has for consequence that the contact moves substantially and becomes unstable. Or the interference is reduced which has for effect to reduce the area under the contact pressure curve according to the distance to the axis of symmetry (FIG. 4) and therefore sealing performance.

That is why there is a need to improve sealing surfaces so as to decrease the risks of jamming, distribute the contact pressures, or resist high transient contact pressures during the assembly of two connections. Indeed, a decrease in the hardness of the material implies a distribution of the contact pressures, which makes it possible to prevent during a screwing reaching the elastic limit of the material, and consequently to also prevent a plastic deformation of the material.

The sealing surfaces in a connection are therefore the result of many design compromises. Generally, the paradigm of these compromises is based on the following aspects: a high material thickness in order to be able to resist the pressure, but a high thickness generates risks of jamming due to an excessively high contact pressure.

In the prior art, the solution of enlarging the contact surface is known, via U.S. Pat. No. 3,870,351, with sealing surface geometries of the toroid type. This solution makes it possible to improve the repeatability of the distribution of contact forces between sealing surfaces during the assembly of two connections. However, this geometry has limitations in the compromise mentioned hereinabove.

The solution proposed by document US2005248153 is known in the prior art concerning sealing surfaces arranged on extended lips so as to give flexibility in movement to the sealing surface during assembly. This document indicates the uniform use of the same type of material for the entire tube, for example meeting the API standards of type P110.

The solution proposed by U.S. Patent 2010/0301603 A1 is known in the prior art concerning an invention in the field of superior tubular threaded joints used to connect tubes made of steel, such as drilling tubes, for example interior or exterior. It is disclosed in particular that the sealing to fluids (liquids or gases) under high pressure results in a mutual radial tightening of the sealing surfaces. The intensity of the radial tightening is according to the relative axial positioning of the male and female threaded elements and is therefore defined by the abutment of these elements by screwing abutments. This document has for purpose to improve the seal of the tubular threaded joint, and in particular of the tubular threaded joint in the ready-to-use structure thereof.

The present document has for purpose to resolve the problems of the aforementioned prior art, by carrying out a portion added by additive manufacturing.

The invention consists of a tubular threaded joint for drilling, operating hydrocarbon wells or transporting oil and gas comprising a male tubular threaded element and a female tubular threaded element, the female tubular threaded element comprising a female internal threaded portion and a female non-threaded portion, the male tubular threaded element comprising a male external threaded portion and a male non-threaded portion, characterised in that at least one of the male or female tubular elements comprises a body and a portion added by additive manufacturing that comprises at least one first sealing surface.

According to an embodiment, the tubular threaded joint is characterised in that the added portion is carried out by additive manufacturing by cladding, by electron beam melting, by metallic powder bed laser melting or “selective laser melting”, by selective laser sintering, by direct metal deposition or “Direct Energy Deposition”, by Binder Spray Deposition or Laser Projection Deposition, by deposition by wire arc additive manufacturing.

According to an embodiment, the tubular threaded joint comprising a second sealing surface on the other of the male or female elements corresponding to the first sealing surface is characterised in that one or the other of the first or second sealing surface is frustoconical and the other toroid.

According to an embodiment the tubular threaded joint is characterised in that the added portion has a hardness less than the hardness of the body over at least 0.6 mm in depth.

According to an embodiment, the tubular threaded joint is characterised in that the added part has a length L greater than or equal to a minimum length Lmin such that:

$$Lmin = 12.8 \times \sqrt{\frac{160 \times e \times intf \times R \times ( 1 - {υ}^{2} )}{π \times {D}_{S}^{2}}} + 2$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an embodiment the tubular threaded joint is characterised in that the added portion has a length L less than or equal to a maximum length Lmax such that:

L max=1.5×L min

According to an embodiment the tubular threaded joint is characterised in that the added portion has a length L greater than or equal to 4 mm.

According to an embodiment the tubular threaded joint is characterised in that the added portion has a thickness Ep greater than or equal to a minimum thickness Epmin such that:

$$Epmin = 5.031 \times \sqrt{\frac{160 \times e \times intf \times R \times ( 1 - {υ}^{2} )}{π \times {D}_{S}^{2}}}$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an embodiment, the tubular threaded joint is characterised in that the added portion has a thickness Ep less than or equal to a maximum thickness Epmax such that:

Ep max=1.5×Ep min

According to an embodiment, the tubular threaded joint is characterised in that the added portion has a thickness Ep greater than or equal to 0.6 mm.

According to an embodiment, the tubular threaded joint is characterised in that the added portion has a friction coefficient greater than the friction coefficient of the body.

According to an embodiment, the tubular threaded joint is characterised in that the added portion comprises a metal chosen from alloy steels, high-alloy steels, cupro-nickel alloy, alloy of titanium, copper, cupronickel, vitroceramic.

According to an embodiment, the tubular threaded joint is characterised in that the added portion comprises a material with a Young's modulus between 110 GPa and 210 GPa, preferably between 110 GPa and 160 GPa.

The invention also comprises a method for carrying out the added portion by additive manufacturing according to the following description:

A method for obtaining a tubular threaded joint in that the added portion is carried out by a method chosen from the methods of cladding, the methods of electron beam melting, the methods of metallic powder bed laser melting or “selective laser melting”, the methods of selective laser sintering, the methods of direct metal deposition or “Direct Energy Deposition”, the methods of Binder Spray Deposition or Laser Projection Deposition, the methods of deposition by wire arc additive manufacturing.

For example tests were conducted with materials of the type, titanium alloys, Fero 55 and stellite with a direct metal deposition method or by deposition by wire arc additive manufacturing.

Alternatively the added portion can be carried out with materials of the ceramic and vitroceramic type by metallic powder bed laser melting method or “selective laser melting”.

Alternatively the added portion can be carried out with materials of the cupro-nickel alloy or micro-alloy steel type by using for example a “wire arc” additive manufacturing technique.

Alternatively a portion (9) added by additive manufacturing can be carried out both on the male tubular element (2) and on the female tubular element (3).

Other characteristics and advantages of the invention shall appear when examining the description that is detailed hereinafter, and the accompanying drawings.

FIG. 1 diagrammatically describes, in a longitudinal cross-section view according to an axis X of the tube, a tubular threaded joint according to a first embodiment wherein the added portion of the male tubular element is carried out by additive manufacturing.

FIG. 2 diagrammatically describes, in a longitudinal cross-section view according to an axis X of the tube, a tubular threaded joint according to a variation of the first embodiment wherein the added portion of the female tubular element is carried out by additive manufacturing.

FIG. 3 describes the contact pressure curve of a connection according to the prior art in comparison with the pressure curve corresponding to a sealing surface according to the invention.

FIG. 4 describes a graph showing the contact pressure curve according to the distance to the axis of symmetry according to the prior art.

FIG. 5 describes a graph showing the contact pressure curve according to the distance to the axis of symmetry according to an alternative of the invention.

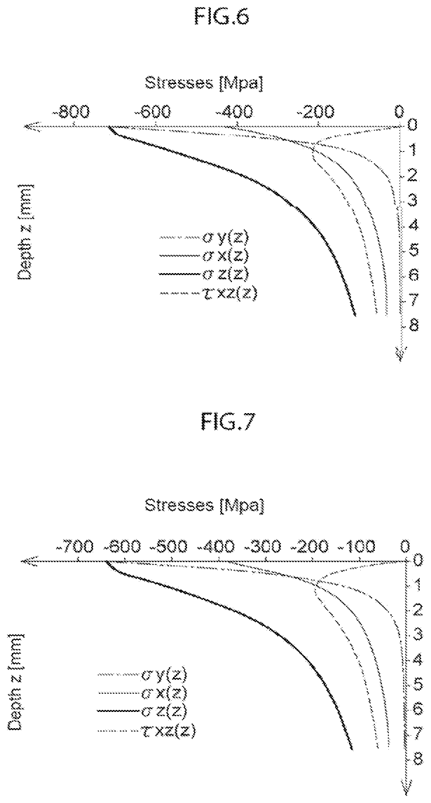

FIG. 6 describes a graph showing the distribution of the stresses according to the depth according to the prior art.

FIG. 7 describes a graph showing the distribution of the stresses according to the depth according to a connection comprising an added portion carried out by additive manufacturing.

The accompanying drawings can be used not only to supplement the invention, but also contribute to the definition thereof, where applicable. They are not limiting as to the scope of the invention.

FIG. 1 describes a tubular threaded joint (1) with an added portion (9) on a male tubular element (2). This added portion (9) is carried out by additive manufacturing and comprises a male sealing surface (10) establishing a metal-metal seal (15). This metal-metal seal (15) provides a seal at the mounted state of the joint and during the use of the joint in a wide spectrum of stresses exerted on the joint, such as an internal pressure, external pressure, compression forces, traction forces.

The tubular threaded joint (1) is shown according to an axial or longitudinal view.

According to an alternative of the invention, the added portion (9) is carried out by additive manufacturing in such a way that the hardness is less than that of the non-added portion, i.e. the male or female body (4) over at least 0.6 mm in depth.

According to another alternative of the invention, the added portion (9) is carried out by additive manufacturing in such a way that the friction coefficient is greater than that of the male or female body (4).

The invention also makes it possible to significantly increase the friction coefficient between the portion added by additive manufacturing and the material of the body of the corresponding tubular element, in comparison with the friction coefficient of the bodies of the male and female tubular element between them.

An increase in the friction coefficient is accompanied by an increase in the value of the screwing torque applicable during a connection of two threaded tubular elements.

The hardness depends in particular on the type of material used, but the materials can be selected in such a way that the hardness is less in the added portion (9) in relation to the male or female body (4).

According to an aspect of the invention, the added portion (9) comprises a metal chosen from alloy steels, high-alloy steels, cupro-nickel alloys, alloys of titanium, ceramic, vitroceramic, or copper, cupronickel, stellite, ferro 55.

Advantageously additive manufacturing makes it possible to obtain a tubular element in the form of a bi-component, (even more components) with for example on one side a type of component or material for the body and on the other side one or more other different components for the added portion. Contrary to the tubular elements of the prior art which are designed according to a mono-component over the entire element.

Advantageously the invention makes it possible to decrease expensive machining operations.

Advantageously the invention makes it possible to increase and to improve the geometrical complexity of the element obtained through a layer-by-layer construction mode.

Advantageously several different portions, for example with a different dimension, complexity, a different material or materials, can be constructed together and at the same time, or then added during the construction.

Advantageously several functionalities can be added with respect to a high level of customisation.

According to an aspect of the invention, the length L is greater than or equal to a minimum length Lmin of the added portion (9) by additive manufacturing and comprising the sealing surface. The length L extends according to the X axis of the tube. This equation can be applied to a toroidal sealing surface or of the torque cone type, i.e. having a radius of curvature R and the cone being either on the male tubular element (2) or on the female tubular element (3). Respectively, the torus being either on the female tubular element (3) or on the male tubular element (2).

This minimum length depends moreover on the sealing diameter Ds, on the interference intf, on the thickness of the lip supporting the sealing surface e, the radius of the toroidal portion R as well as on Poisson's ratio of the material v. The multiplying coefficient 12.8 is applied. This coefficient takes account of the relative movement between the male element during stresses of the traction/compression type. Indeed, by way of example, under tension, the female non-threaded portion (6) i.e. the length of the female tubular element between the threading and the abutment, is extended and therefore the contact will be shifted. Thus the coefficient of 12.8 takes these variations into account so that it can be ensured that when a traction/compression is applied or any other form of pressure, the sealing surface of the portion carried out by additive manufacturing indeed remains in contact on the corresponding surface. An addition of +2 is made as a margin of safety.

Lmin is such that:

$$Lmin = 12.8 \times \sqrt{\frac{160 \times e \times intf \times R \times ( 1 - {υ}^{2} )}{π \times {D}_{S}^{2}}} + 2$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an alternative of the invention the added portion (9) has a length L greater than or equal to 4 mm.

According to another aspect, the portion (9) added by additive manufacturing and comprising the sealing surface has a thickness Ep greater than or equal to a minimum thickness Epmin. This equation can be applied to a toroidal sealing surface or of the torque cone type, i.e. having a radius of curvature R.

This minimum thickness (or height) Epmin depends on the sealing diameter Ds, on the interference intf, on the thickness of the lip supporting the sealing surface e, the radius of the toroidal portion R as well as on Poisson's ratio of the material v. The multiplying coefficient 5.031 is applied. This coefficient corresponds to the half-length of the contact that multiplied by 0.7861 makes it possible to calculate the depth for which the shear stress is maximal i.e. (12.8/2)×0.7861≈5.031. “0.7861” corresponds to the coefficient of the Hertz theory in the framework of a lineic contact.

Epmin is such that:

$$Epmin = 5.031 \times \sqrt{\frac{160 \times e \times intf \times R \times ( 1 - {υ}^{2} )}{π \times {D}_{S}^{2}}}$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an alternative of the invention the added portion (9) has a thickness Ep greater than or equal to 0.6 mm.

It has been observed that the maximum length Lmax could be set to 1.5 times the minimum length, which makes it possible to ensure the operation of the portion added by additive manufacturing without having to carry out an excessively large portion as additive manufacturing, and to thus avoid unnecessary additional costs.

In the same way, the maximum thickness Epmax of the portion added by additive manufacturing can be set to 1.5 times the minimum thickness of the portion added by additive manufacturing.

The figure and the sizing for the added portion (9) of the tubular threaded joint (1) were selected in terms of a diagrammatical representation.

FIG. 2 describes, according to another variation of the invention, a tubular threaded joint (1) with an added part (9) on a female tubular element (3). This added portion (9) is carried out by additive manufacturing and comprises a female sealing surface (11) establishing a metal-metal seal (15). According to an alternative of the invention, the added portion (9) is carried out by additive manufacturing in such a way that the hardness is less than that of the non-added portion, i.e. the male or female body (4) over at least 0.6 mm in depth.

According to another alternative of the invention, the added portion (9) is carried out by additive manufacturing in such a way that the friction coefficient is greater than that of the male or female body (4).

According to an aspect of the invention, the length L is greater than or equal to a minimum length Lmin of the added portion (9) by additive manufacturing and comprising the sealing surface. This equation can be applied to a toroidal sealing surface or of the torque cone type, i.e. having a radius of curvature R and the cone being either on the male tubular element (2) or on the female tubular element (3). Respectively, the torus being either on the female tubular element (3) or on the male tubular element (2).

This minimum length depends moreover on the sealing diameter Ds, on the interference intf, on the thickness of the lip supporting the sealing surface e, the radius of the toroidal portion R as well as on Poisson's ratio of the material v. The multiplying coefficient 12.8 is applied. This coefficient takes account of the relative movement between the male element during stresses of the traction/compression type. Indeed, by way of example, under tension, the female non-threaded portion (6) i.e. the length of the female tubular element between the threading and the abutment, is extended and therefore the contact will be shifted. Thus the coefficient of 12.8 takes these variations into account so that it can be ensured that when a traction/compression is applied or any other form of pressure, the sealing surface of the portion carried out by additive manufacturing indeed remains in contact on the corresponding surface. An addition of +2 is made as a margin of safety.

Lmin is such that:

$$Lmin = 12.8 \times \sqrt{\frac{160 \times e \times intf \times R \times ( 1 - {υ}^{2} )}{π \times {D}_{S}^{2}}} + 2$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an alternative of the invention the added portion (9) has a length L greater than or equal to 4 mm.

According to another aspect, the portion (9) added by additive manufacturing and comprising the sealing surface has a thickness Ep greater than or equal to a minimum thickness Epmin. This equation can be applied to a toroidal sealing surface or of the torque cone type, i.e. having a radius of curvature R.

This minimum thickness (or height) Epmin depends on the sealing diameter Ds, on the interference intf, on the thickness of the lip supporting the sealing surface e, the radius of the toroidal portion R as well as on Poisson's ratio of the material v. The multiplying coefficient 5.031 is applied. This coefficient corresponds to the half-length of the contact that multiplied by 0.7861 makes it possible to calculate the depth for which the shear stress is maximal i.e. (12.8/2)×0.7861≈5.031. “0.7861” corresponds to the coefficient of the Hertz theory in the framework of a lineic contact.

Epmin is such that:

$$Epmin = 5.031 \times \sqrt{\frac{160 \times e \times intf \times R \times ( 1 - {υ}^{2} )}{π \times {D}_{S}^{2}}}$$

Where:

e value of the thickness of a lip supporting the toroidal sealing surface;

intf value of the interference;

R value of the radius of curvature of the toroidal sealing surface;

v value of Poisson's ratio of the material of the toroidal sealing surface;

Ds value of the sealing diameter.

According to an alternative of the invention the added portion (9) has a thickness Ep greater than or equal to 0.6 mm.

It has been observed that the maximum length Lmax could be set to 1.5 times the minimum length, which makes it possible to ensure the operation of the portion added by additive manufacturing without having to carry out an excessively large portion as additive manufacturing, and to thus avoid unnecessary additional costs.

In the same way, the maximum thickness Epmax of the portion added by additive manufacturing can be set to 1.5 times the minimum thickness of the portion added by additive manufacturing.

The figure and the sizing for the added portion (9) of the tubular threaded joint (1) was selected in terms of a diagrammatical representation.

FIG. 3 shows a contact pressure curve of a connection according to the prior art and another curve corresponding to a sealing surface according to the invention. The X-axis corresponds to the longitudinal position along a sealing surface. The Y-axis corresponds to the contact pressure.

The curve 21 corresponds to a representation of the contact pressure according to the longitudinal position along a sealing surface of a connection according to the prior art. The curve 22 corresponds to a representation of the contact pressure according to the longitudinal position along a sealing surface of a connection according to the invention, i.e. a connection comprising a portion carried out by additive manufacturing, this portion comprising the sealing surface, and the material being of a hardness that is not as high as the base material of the connection.

The curve 21 showing the distribution of the contact pressure is generally a parabola, having a peak. This peak exceeds the threshold Pg corresponding to a pressure starting from which the risk of jamming is high.

The curve 22 shows that the contact pressure of a connection according to the invention is distributed over a larger width, and decreases the level of the contact pressure distribution peak, in such a way that the threshold Pg is not reached. Note also that the surface of the curve 22 is more substantial than the surface of the curve 21. That is to say the contact force between the sealing surfaces is greater on a connection according to the invention than on a connection of the prior art. With a connection according to the invention, it is therefore possible to increase the contact pressure between sealing surfaces while decreasing the risk of jamming of the sealing surfaces.

FIG. 4 shows the contact pressure according to the distance to the axis of symmetry according to the prior art between two sealing surfaces. The connection is entirely carried out with steel with an elasticity modulus E1 of a value of 210,000 Mpa. The sealing surface is subjected to a contact force of 70,000 N and the radius of curvature of the toroidal sealing surface is 100 mm. There is no portion added by additive manufacturing according to the invention.

FIG. 5 shows the contact pressure according to the distance to the axis of symmetry according to the invention between two sealing surfaces. The connection is carried out on one side with the body (4) made of steel with an elasticity modulus E1 of a value of 210,000 Mpa and on the other side with the added portion (9) comprising a toroidal sealing surface, carried out with a steel with an elasticity modulus E2=140,000 Mpa. The sealing surface is subjected to a contact force of 70,000 N and the radius of curvature of the toroidal sealing surface is 100 mm.

By comparing FIGS. 4 and 5, only the presence of a portion (9) added by additive manufacturing of a different material and of a lesser Young's modulus and comprising the toroidal sealing surface distinguishes the two connections.

The comparison thus clearly shows that adding an added portion (9) according to the invention presented with respect to the prior art, a decreased contact pressure peak passing from about 710 Mpa in FIG. 4 to 640 Mpa in FIG. 5. On another side, the distance to the axis of symmetry increases by passing from 1.25 mm to 1.45 mm. Thus it is observed that the contact pressure width is increased, passing from 2.5 mm to 2.9 mm while the value of the contact pressure peak passes at the same time from about 710 Mpa to 640 Mpa. Moreover by taking into consideration the parameters of FIG. 4 there is a half-surface area of 596 which is an area under the curve equal to 1192. Taking into consideration the parameters of FIG. 5, there is a half-surface area of 618 which is an area under the curve of 1236. An increase in the area under the curve results in an increase in sealing performance.

The invention therefore makes it possible with respect to the prior art not only to decrease the contact pressure peak, to increase the distribution of the contact pressure while increasing the area under the curve, i.e. while increasing the sealing performance.

FIG. 6 shows the distribution of the stresses according to the depth according to the prior art. The various stresses are represented according to the curves σy(z), σx(z), σz(z) and τxz(z). It is observed that as z increases, i.e. the further away from the surface and the further the depth is, the more the stresses decrease.

FIG. 7 shows the distribution of the stresses according to the depth according to a connection comprising an added portion (9) carried out by additive manufacturing. The various stresses are represented according to the curves σy(z), σx(z), σz(z) and τxz(z). It is observed that as z increases, i.e. the further away from the surface and the further the depth is, the more the stresses decrease.

By comparing the result of FIGS. 6 and 7, the stresses according to the invention are clearly more reduced with respect to the stresses according to the prior art whether at the surface (z=0), or in depth (z=4 for example).

This shows that with a connection according to the invention, it is possible to increase the interference without increasing the risks of jamming.

1-14. (canceled)

15. A tubular threaded joint for drilling, operating hydrocarbon wells, or transporting oil and gas, the tubular threaded joint comprising:
a male tubular threaded element and a female tubular threaded element, the female tubular threaded element comprising a female internal threaded portion and a female non-threaded portion, the male tubular threaded element comprising a male external threaded portion and a male non-threaded portion, at least one of the male or female tubular elements comprises a body and a portion added by additive manufacturing that comprises at least one first sealing surface,
wherein said tubular threaded joint comprises a second sealing surface on the other of the male or female elements corresponding to the first sealing surface,
wherein one or the other of the first or second sealing surface is frustoconical and the other sealing surface is toroid, and
wherein the added portion has a length L greater than or equal to a minimum length Lmin such that:
$$Lmin = 12.8 \times \sqrt{\frac{160 \times e \times intf \times R \times ( 1 - {υ}^{2} )}{π \times {D}^{2}}} + 2$$
Where:
e value of the thickness of a lip supporting the toroidal sealing surface;
intf value of the interference;
R value of the radius of curvature of the toroidal sealing surface;
v value of Poisson's ratio of the material of the toroidal sealing surface;
Ds value of the sealing diameter.

16. The tubular threaded joint according to claim 15, wherein the added portion is carried out by additive manufacturing by cladding, by electron beam melting, by metallic powder bed laser melting or “selective laser melting”, by selective laser sintering, by direct metal deposition or “Direct Energy Deposition”, by Binder Spray Deposition or Laser Projection Deposition, by deposition by wire arc additive manufacturing.

17. The tubular threaded joint according to claim 15, wherein the added portion has a hardness less than the hardness of the body over at least 0.6 mm in depth.

18. The tubular threaded joint according to claim 15, wherein the length L of the added portion is less than or equal to a maximum length Lmax such that:
L max=1.5×L min.

19. The tubular threaded joint according to claim 15, wherein the length L of the added portion is greater than or equal to 4 mm.

20. The tubular threaded joint according to claim 15, wherein the added portion has a thickness Ep greater than or equal to a minimum thickness Epmin such that:
$$Epmin = 5.031 \times \sqrt{\frac{160 \times e \times intf \times R \times ( 1 - {υ}^{2} )}{π \times {D}_{S}^{2}}}$$
Where:
e is a value of the thickness of a lip supporting the toroidal sealing surface;
intf is a value of the interference;
R is a value of the radius of curvature of the toroidal sealing surface;
v is a value of Poisson's ratio of the material of the toroidal sealing surface;
Ds is a value of the sealing diameter.

21. The tubular threaded joint according to claim 20, wherein the thickness Ep of the added portion is less than or equal to a maximum thickness Epmax such that:
Ep max=1.5×Ep min.

22. The tubular threaded joint according to claim 15, wherein the added portion has a thickness Ep greater than or equal to 0.6 mm.

23. The tubular threaded joint according to claim 15, wherein the added portion has a friction coefficient greater than a friction coefficient of the body.

24. The tubular threaded joint according to claim 15, wherein the added portion comprises a metal chosen from alloy steels, high-alloy steels, cupro-nickel alloys, alloys of titanium, ceramic, vitroceramic, or copper, cupronickel, stellite, ferro 55.

25. The tubular threaded joint according to claim 15, wherein the added portion comprises a material with a Young's modulus between 110 GPa and 210 GPa.

26. The tubular threaded joint according to claim 15, wherein the added portion comprises a material with a Young's modulus between 110 GPa and 160 GPa.

27. A method for obtaining the tubular threaded joint according to claim 15, comprising:
carrying out the added portion by a method chosen from cladding, electron beam melting, metallic powder bed laser melting or “selective laser melting”, selective laser sintering, direct metal deposition or “Direct Energy Deposition”, Binder Spray Deposition or Laser Projection Deposition, and deposition by wire arc additive manufacturing.
